(19) United States
(12) Patent Application Publication
(10) Pub. No.: US 2007/0017509 A1
(43) Pub. Date: Jan. 25, 2007

(54) Device and method for a protective mask

(76) Inventors: Ingemar Emricson, Bankeryd (SE); Jonas Malm, Huskvarna (SE)

Correspondence Address: ALBIHNS STOCKHOLM AB, BOX 5581, LINNEGATAN 2, SE-114 85 STOCKHOLM; SWEDENn, STOCKHOLM, SE

(21) Appl. No.: 10/558,206

(22) PCT Filed: May 18, 2004
(86) PCT No.: PCT/SE04/00766

§ 371 Date: Nov. 25, 2005

(30) Foreign Application Priority Data
Jun. 3, 2003 (SE) 0301615-1

(51) Int. Cl. A62B 18/00

(52) U.S. Cl. 128/201.24

(57) ABSTRACT

The present invention concerns a device and method for a protective mask comprising means (3) for detecting that a protective-mask user is breathing through the breathing filter of the protective mask. The invention is characterized in that the means for detecting protective-mask use are arranged to sense the underpressure that arises in the protective mask during inhalation.

### TECHNICAL AREA

This invention concerns a device for a protective mask comprising means to detect that a protective-mask user is breathing through the breathing filter of the protective mask as per the preamble to claim 1.

The invention also concerns a method for detecting that a protective-mask user is breathing through the breathing filter of the protective mask.

### STATE OF THE ART

During military exercises, efforts are made to practice situations that could arise during actual combat. One of the situations that can arise is when an area is exposed to gas attack, in which situations it is decisive that the soldiers wear protective masks.

Simulating systems currently exist that can be used to train soldiers in what to do in the event of a gas attack. These simulating systems comprise a central unit that communicates with software and/or hardware in soldier-borne vests. During the simulation of a gas attack the central unit transmits information concerning the gas attack to the software/hardware in the vests. The soldiers should carry with them protective masks, which must be donned in the event of a gas attack. The normal filter in the protective mask is replaced with a simulator filter. The simulator filter detects an inhalation pressure and communicates breathing activity to the vest software/hardware via an IR link. The breathing activity is processed in the software/hardware together with information from the central unit concerning the gas attack in order to determine whether the protective mask has been donned and the soldier is breathing through the breathing filter within a given time frame after the gas attack, in which case no actions are taken. If the protective mask has not been donned within the given time frame, the software/hardware determines that the solider has been wounded or killed.

### DESCRIPTION OF THE INVENTION

One object of the present invention is to improve the simulator filter that is used in protective masks for use in connection with the simulation of a gas attack.

This has been achieved by means of a device for a protective mask comprising means to detect that a protective-mask user is breathing through the breathing filter of the protective mask, which device is characterized in that the means for detecting protective-mask use are arranged so as to sense the underpressure that arises in the protective mask during inhalation. For example, a pressure difference sensor arranged to measure a pressure difference between the pressure in the protective mask and the ambient pressure is used to sense the underpressure. By sensing the pressure difference, it is possible to determine with a high degree of certainty whether inhalation through the protective mask is actually taking place. Measuring the differential pressure as described above affords a number of advantages. First, no account needs to be taken of changes in atmospheric pressure which can occur, e.g. during changes in the weather or in connection with movement between locations that are situated at different elevations about sea level. Furthermore, it is common practice to establish overpressure inside vehicles in order to prevent toxic gases from penetrating. It is very likely that the protective mask would be used in just such situations, both at the elevated pressure and before there has been enough time to establish the overpressure. Another advantage is that the electronics do not need to be calibrated as the components age, or in connection with operation in varying temperatures.

To further increase the possibility of determining whether inhalation through the protective mask is occurring, the pressure difference sensor is connected to a processing unit arranged to compare the pressure difference values with a reference pattern for a breath in order to determine whether the pattern of the pressure changes agrees with the reference pattern. The reference pattern can be individually adapted and based on previously measured values.

Additional processing of the data from the pressure difference sensor in the processing unit further makes it possible to determine how large a volume of air is being inhaled in a selected breath and/or breathing rate. Using information about the volume of air per breath and breathing rate, the proper usage of the protective mask can be practiced so that inhalation can occur correctly. In addition, the information provides knowledge concerning the physical stress and degree of concentration of an individual who is using the protective mask. Following analysis of the information, an indication of the condition level of the protective-mask user can also be obtained.

To distribute the information compiled by the processing unit, the processing unit is arranged so as to generate status reports containing the compiled information, and to supply said reports to a transmitter for transmission by, e.g. radio.

The invention also concerns a method for detecting that a protective-mask user is breathing through the breathing filter of the protective mask. The method is characterized in that the underpressure that arises in the protective mask during inhalation is sensed in order to detect protective-mask use.

### BRIEF DESCRIPTION OF FIGURES

FIG. 1 shows an example of an encapsulation for a simulator filter for a protective mask.

FIG. 2. shows an example of the structure of the simulator filter in FIG. 1.

FIG. 3 shows a block diagram that illustrates the function of the simulator filter.

### PREFERRED EMBODIMENTS

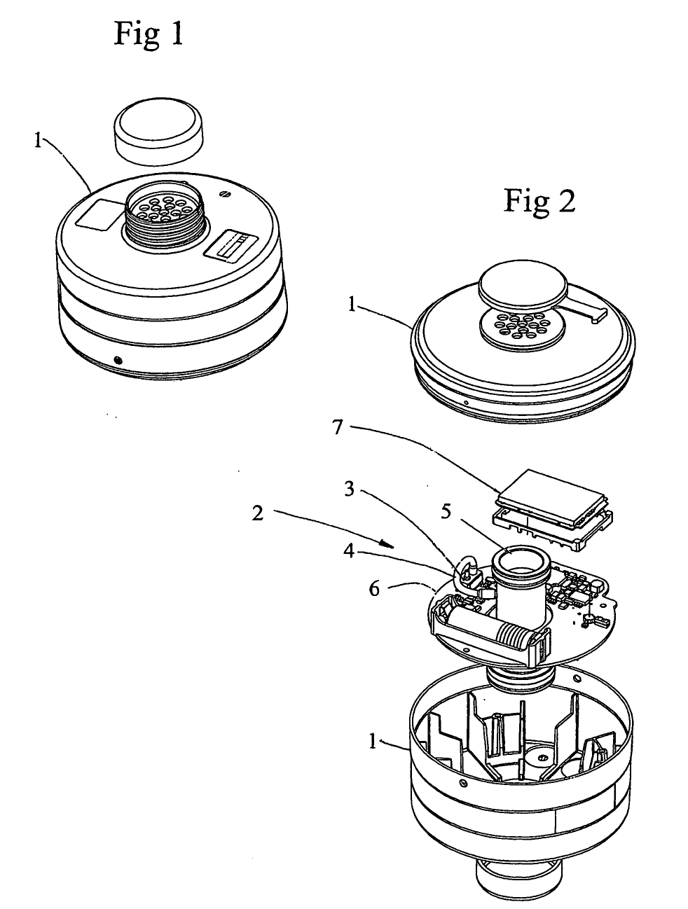

In FIG. 1, reference number 1 designates an encapsulation for a simulator filter 2 (seen in FIG. 2) for use in a protective mask. The encapsulation is designed outwardly in the same way as an encapsulation for the normal breathing filter of the protective mask. The encapsulation 1 of the simulator filter thus has the same threaded socket and protective cover as the normal breathing filter. The normal breathing filter of the protective mask can thus easily be removed and replaced with the simulator filter when the protective mask is to be used in simulated gas attack exercises.

In FIG. 2, the simulator filter 2 comprises a pressure difference sensor 3 that senses the underpressure that arises in the protective mask during inhalation. The sensor 3 is in pressure communication both with the volume of air that is present inside the protective mask and the ambient air. As a result, the sensor 3 can detect the pressure differences that arise inside the protective mask as a function of inhalation. In the example in the figure, the pressure difference sensor 3 is connected via a hose 4 to an air intake 5. The air intake 5 functions as an inhalation tube. The air pressure in the air intake 5 indicates the air pressure inside the protective mask. The air pressure in the space around the sensor is also measured. The encapsulation comprises valves for pressure equalization (not shown), whereupon the air pressure at the sensor 3 indicates the ambient pressure.

The expiration air passes via a one-way valve (not shown) mounted on the protective mask and out into the surroundings. Note that the expiration thus never passes through the simulator filter. The simulator also has an air resistance in order to emulate a real breathing filter. The air resistance is adjustable by changing the dimensions of the air intake opening (not shown) realized in the air intake 5 of the simulator filter. The simulator filter 2 also comprises a circuit board 6 that is connected to the sensor 3 and contains electrical circuits, as well as a processor and memory circuits, plus a radio transmitter 7; these components will be described in detail below.

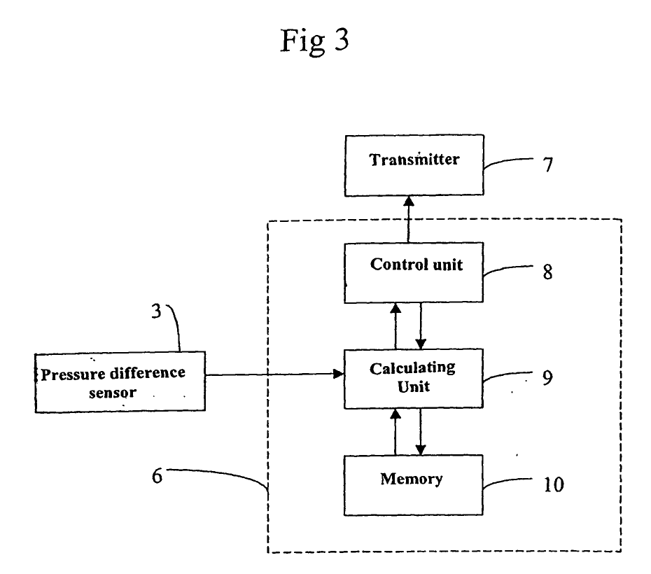

In FIG. 3, the electrical circuits of the circuit board 6 are described as two mutually physically separated units, a control unit 8 and a calculating unit 9 connected to a memory 10. One skilled in the art will perceive that the function described below, which is achieved with the control unit and calculating unit, could also be achieved by using entirely different system designs.

In the example illustrated herein, the control unit 8 controls the function of the simulator filter 2. In detail, the control unit 8 controls the simulator filter 2 between a standby mode, an awake mode and an active mode, in which different modes the simulator filter functions according to different principles. In standby mode the control unit 8 controls the calculating unit 9, which is operatively connected with the pressure difference sensor 3, so as to retrieve pressure difference data from the pressure difference sensor approximately one to two times per minute, and to compare the input pressure difference data with a preset value. As long as the preset value is not exceeded, the filter remains in standby mode. When the preset value is exceeded, the calculating unit 9 reports this to the control unit 8, whereupon the control unit 8 changes over to working in awake mode.

In awake mode, a check is run to determine that breathing is present. In detail, the control unit 8 controls the calculating unit 9 so as to compare the measured values from the pressure difference sensor with the reference values that form a reference pattern for a breath over a selected preset length of time on the order of several seconds, e.g. five to ten seconds. The reference values are either permanently stored in a memory 10 that is connected to the calculating unit 9, or the reference values are modifiable so that they can be adapted for the individual who is breathing through the simulator filter in the present instance. In the modifiable embodiment, a new reference pattern can be built up based on previously measured values. During the comparison between the reference values and the measured values, data are retrieved from the pressure sensor at short intervals, e.g. 5-10 times per second. If, in awake mode, the calculating unit 9 determines that no breathing has been detected, it reports this to the control unit, whereupon the control unit resumes standby mode. If, on the other hand, the calculating unit 9 in awake mode does determine that breathing has been detected, then the control unit 8 will supply a status report to the radio transmitter 7, which informs that the protective mask is being used. In addition, the control unit assumes its active mode.

In active mode, the radio transmitter 7 is supplied at regular intervals with a new status report indicating that the protective mask is being used; this occurs e.g. every five to ten seconds. The active mode is maintained as long as new breaths are detected. If no new breaths are detected, the calculating unit 9 notifies the control unit 8 of this, whereupon the control 8 resumes standby mode. In active mode, the detection process functions in the same way as in awake mode, i.e. new data are input to the calculating unit 9 from the pressure sensor a number of times per second, and the input data are compared with a fixed or adapted reference pattern.

In an expanded embodiment, the calculating unit 9 is arranged so that, in active mode, it determines how large a volume of air has been inhaled in the selected breaths. For example, each breath can be selected, or every second, or every third breath. According to this embodiment, the air volume information is incorporated into the status reports that are supplied to the transmitter. The calculating unit 9 can also be arranged so as to determine the breathing rate. Using these two parameters, i.e. air volume per breath and breathing rate, it is then possible, via the information in the status reports, to determine whether soldiers using the protective mask are actually breathing through the protective masks, and thus practicing breathing through the masks in such a way that they are breathing as correctly and efficiently as possible. The characteristics of the breathing also indicate, e.g. the physical stress level and degree of concentration of the soldier. Analysis of the information in the status reports can also, after analysis, provide an indication of the condition level of the soldier.

In the example described herein, the transmitter is a radio transmitter. The transmitter could alternatively be of some other type, such as an IR transmitter.

In one embodiment the transmitter is arranged so that, during an exercise, it will transmit the status reports directly to a central unit that receives data from all the soldiers participating in the exercise. The transmitter can alternatively be arranged to transmit at a short range, characteristically about one meter. In this embodiment the soldiers wear vests containing communication equipment and electronics that receive the status reports transmitted by the transmitter. The communication equipment in the vest can then be arranged to forward the status reports to the central unit.

1. A device for a protective mask comprising means for detecting that a protective-mask user is breathing through the breathing filter of the protective mask, wherein the means for detecting protective-mask use comprise a pressure difference sensor arranged to measure a pressure difference between the pressure in the protective mask and the ambient pressure, and in that a processing unit connected to the pressure difference sensor is arranged so as to compare the pressure difference values with a reference pattern for a breath in order to determine whether the pattern of the pressure changes agrees with the reference pattern.

2. A device according to claim 1, wherein the reference pattern is individually adapted and based on previously measured values.

3. A device according to claim 1, wherein the processing unit is arranged to create a status report that indicates whether the pattern of the pressure changes agrees with the reference pattern, and to supply said reports to a transmitter.

4. A device according to claim 1, wherein the processing unit is arranged to determine how large a volume of air is being inhaled in selected breaths.

5. A device according to claim 1, wherein the processing unit is arranged to determine a breathing rate.

6. A device according to claim 3, wherein the breathing filter of the protective mask is a simulator filter, and in that the pressure difference sensor, processing unit and transmitter are incorporated into the simulator filter.

7. A method for detecting that a protective-mask user is breathing through the breathing filter of the protective mask, wherein a pressure difference between the pressure in the protective mask and the ambient pressure is measured to detect protective-mask use, and in that the pressure difference values are compared with a reference pattern for a breath in order to determine whether the pattern of the pressure difference values agrees with the reference pattern.
